(19) United States
(12) Patent Application Publication
(10) Pub. No.: US 2016/0155429 A1
(43) Pub. Date: Jun. 2, 2016

(54) INFORMATION PROCESSING APPARATUS AND TERMINAL DEVICE

(71) Applicant: FUJITSU LIMITED, Kawasaki-shi (JP)

(72) Inventors: Kazuki Matsui, Kawasaki (JP); Tomoharu Imai, Kawasaki (JP)

(73) Assignee: FUJITSU LIMITED, Kawasaki-shi (JP)

(21) Appl. No.: 14/926,811

(22) Filed: Oct. 29, 2015

(30) Foreign Application Priority Data
Nov. 27, 2014 (JP) 2014-240582

(51) Int. Cl. G09G 5/39; G06T 1/60

(52) U.S. Cl. CPC G09G 5/39; G06T 1/60; G09G 2340/02; G09G 2370/16

(57) ABSTRACT

An information processing apparatus includes an image memory and a processor. The image memory is configured to hold an image of a displayable area larger than an area of an image displayed in a display unit of a terminal device. The processor is configured to transmit the image of the displayable area to the terminal device and divide the displayable area into a plurality of divided areas. The processor is configured to determine a change frequency less frequently for a non-displayed divided area than for a displayed divided area. The processor is configured to compress an image of a displayable area other than a frequently changed area with a first compression ratio. The processor is configured to compress an image of the frequently changed area with a second compression ratio higher than the first compression ratio. The processor is configured to transmit the compressed image to the terminal device.

### CROSS-REFERENCE TO RELATED APPLICATION

This application is based upon and claims the benefit of priority from the prior Japanese Patent Application No. 2014-240582, filed on Nov. 27, 2014, the entire contents of which are incorporated herein by reference.

### FIELD

The embodiment discussed herein is related to an information processing apparatus and a terminal device.

### BACKGROUND

A system called a thin client has been known. A thin client system is a system configured in such a way that a client terminal is equipped only with minimum required functions and a server manages resources such as an application or a file.

The thin client system acts as if a client terminal itself performs processing or holds data though a result of processing performed by a server or data held in the server is actually displayed in the client terminal.

When screen data intended to be displayed in the client terminal is transmitted between the server and the client terminal, a screen update occurs in response to an operation by a user. When the screen update occurs in the thin client system, differential screen data between before and after the screen update is transmitted from the server to the client terminal. Here, for example, in a case where a Web page is displayed by a Web browser, when the Web page is vertically long, only a portion of the Web page is displayed in a display area of the Web browser. In this case, when information on the scroll operation of the Web page is sent from the client terminal to the server, differential screen data corresponding to a scroll amount is transmitted for the remaining portion of the Web page.

For example, descriptions will be made on the transmission of the screen data from the server to the client terminal with reference to FIG. 7. FIG. 7 is a diagram illustrating an example of a screen data transmission method. A Web page is displayed by the Web browser on the server. When the entirety of the Web page exceeds the screen size of the client terminal, only a portion (screen size of the client terminal) of the Web page is displayed in a Web browser screen. In this case, it is assumed that a user of the client terminal intends, by a scroll operation, to display a portion which is not displayed in the screen. In such a case, when the scroll operation received by the client terminal is notified to the server, the server compresses the differential data for the updated screen after the scrolling and transmits the compressed differential data to the client terminal. In the example of FIG. 7, the server compresses data of a portion of the Web page, which is included in an area “b” and is not included in an area “a”, and transmits the compressed data of the portion to the client terminal.

Related techniques are disclosed in, for example, Japanese Laid-open Patent Publication No. 2011-59226, Japanese Laid-open Patent Publication No. 2013-142751, Japanese Laid-open Patent Publication No. 2013-214321, and Japanese Laid-open Patent Publication No. 2011-238014.

In a conventional screen data transmission technique of a thin client system, a server may deteriorate operation performance with respect to a scroll operation in a client terminal.

For example, since the server displays a portion (with a screen size of the client terminal) of the Web page on the Web browser screen, data of the difference between the portion of the Web page and a new updated screen after the scrolling is transmitted to the client terminal each time when the scroll operation is performed in the client terminal. That is, the server synchronizes the screen of server with the screen of client terminal each time when the scroll operation is performed in the client terminal. Accordingly, there may be a case where a delay occurs until the updated screen is displayed after the scroll operation is performed in the client terminal side such that the server deteriorates the operation performance in the client terminal. In a case where a transfer amount of screen data is large, the server further deteriorates the operation performance in the client terminal.

### SUMMARY

According to an aspect of the present invention, provided is an information processing apparatus including an image memory and a processor. The image memory is configured to hold an image of a displayable area larger than an area of an image displayed in a display unit of a terminal device. The processor is configured to transmit the image of the displayable area held in the image memory to the terminal device, The processor is configured to divide the displayable area into a plurality of divided areas, The processor is configured to determine a change frequency for each of the plurality of divided areas such that the change frequency is determined less frequently for a non-displayed divided area than for a displayed divided area, the change frequency being a frequency of change in an image of each of the plurality of divided areas, an image of the non-displayed divided area not being displayed in the display unit of the terminal device, an image of the displayed divided area being currently displayed in the display unit of the terminal device, The processor is configured to identify, as a frequently changed area, a divided area for which the change frequency exceeds a predetermined threshold value, The processor is configured to compress an image of a first divided area with a first compression ratio to obtain a first compressed image, the first divided area not being identified as the frequently changed area, The processor is configured to compress an image of a second divided area with a second compression ratio higher than the first compression ratio to obtain a second compressed image, the second divided area being identified as the frequently changed area, and The processor is configured to transmit the first compressed image and the second compressed image to the terminal device.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating configurations of respective apparatuses included in a thin client system according to an embodiment;

FIG. 2A is a diagram illustrating a specific example of a change frequency determination according to an embodiment;

FIG. 2B is a diagram illustrating a specific example of a change frequency determination according to an embodiment;

FIG. 3 is a diagram illustrating a specific example of a communication control according to an embodiment;

FIG. 4A is a flowchart illustrating a flow of an image transmission process of a GW server according to an embodiment;

FIG. 4B is a flowchart illustrating a flow of an image transmission process of a GW server according to an embodiment;

FIG. 5 is a flowchart illustrating a flow of an image display process of a client terminal according to an embodiment;

FIG. 6 is a diagram illustrating an example of a computer executing an image transmission program, and

FIG. 7 is a diagram illustrating an example of a screen data transmission method.

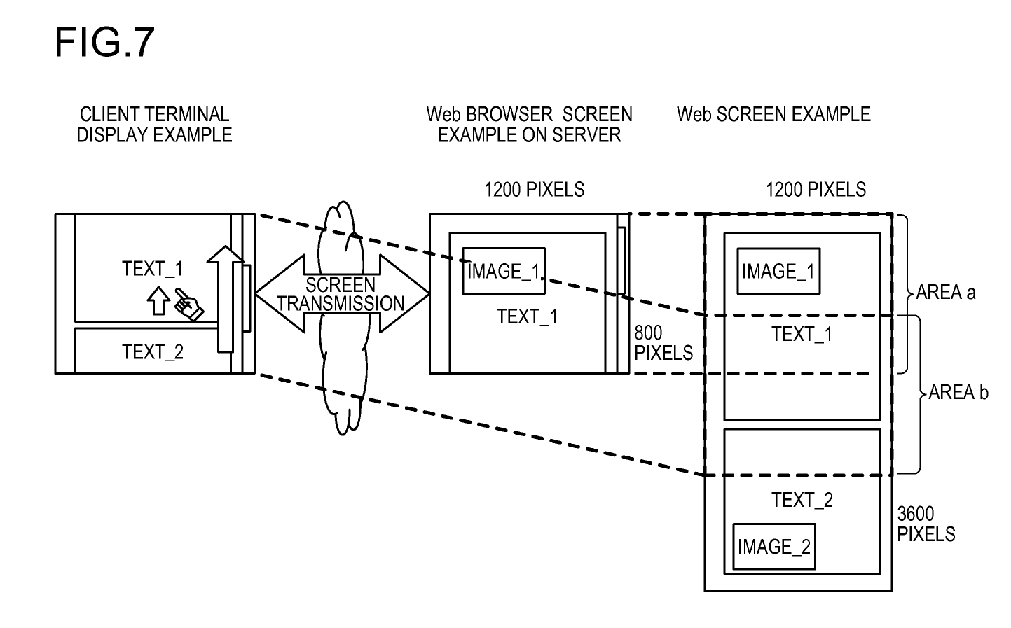

### DESCRIPTION OF EMBODIMENT

Hereinafter, an embodiment of an information processing apparatus and a terminal device will be described in detail with reference to accompanying drawings. The present disclosure is not limited to the embodiment.

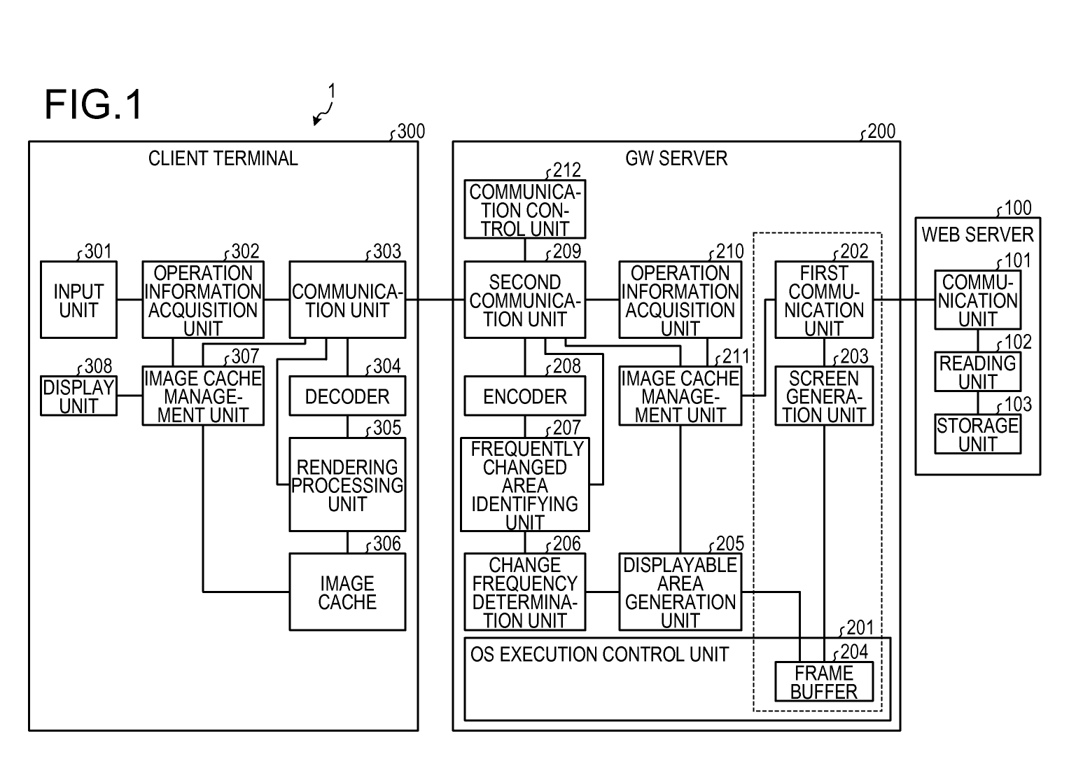

First of all, descriptions will be made on a configuration of a thin client system according to the present embodiment. FIG. 1 is a diagram illustrating configurations of respective apparatuses included in a thin client system according to the embodiment. A thin client system 1 illustrated in FIG. 1 causes a gate way (GW) server 200 which is a relaying apparatus to remotely control a screen displayed by a client terminal 300. That is, the thin client system 1 acts as if the client terminal 300 itself performs processing or holds data though a result of processing performed by the GW server 200 or data held in the GW server 200 is actually displayed in the client terminal 300.

The thin client system 1 illustrated in FIG. 1 includes a Web server 100 which is a server apparatus, the GW server 200 which is a relaying apparatus, and the client terminal 300. In the example of FIG. 1, a case where a single Web server 100 and a single client terminal 300 are connected to a single GW server 200 is illustrated. However, an arbitrary number of Web servers and client terminals may be connected to the GW server 200.

The Web server 100, the GW server 200, and the client terminal 300 are communicably connected with each other through a predetermined network. As the network, regardless of a wired or wireless communication network, any kind of communication network, such as the Internet, a local area network (LAN), or a virtual private network (VPN) may be employed. It is assumed that a remote frame buffer (RFB) protocol used in virtual network computing (VNC) is employed as an example of a communication protocol between the GW server 200 and the client terminal 300.

The Web server 100 is a server apparatus to deliver contents, and delivers Web pages as the contents. In response to a page request issued from the GW server 200, the Web server 100 transmits a Web page corresponding to the requested page to the GW server 200. In the following descriptions, a Web page may be simply referred to as a page.

The GW server 200 is a computer that provides a service for remotely controlling a screen to be displayed on the client terminal 300. In the GW server 200, an application for a remote screen control for a server is installed or pre-installed. In the following, the application for a remote screen control for a server may be referred to as a “server side remote screen control application”.

The server side remote screen control application includes a function of providing a remote screen control service as a basic function. For example, the server side remote screen control application acquires information on an operation performed at the client terminal 300 and then, causes an application activated in its own device to perform processing requested by the operation. The server side remote screen control application also generates a screen for displaying a result of processing performed by the application and then, transmits the screen to the client terminal 300. A screen size of the generated screen has a limitation on the number of vertical pixels depending on a memory or an operating system (OS) installed in GW server 200. For example, when the OS is Windows (registered trademark), the screen size has 1200 horizontal pixels to the maximum and 2048 vertical pixels to the maximum. In this case, the server side remote screen control application transmits an image of an area including pixels of a portion different from a bitmap image of a displayable area which has been stored in the client terminal 300 before the current screen is generated, that is, the server side remote screen control application transmits an image of an updated rectangle. The displayable area described above refers to an area having the same size as the screen size of the GW server 200 and the size is larger than an area of the bitmap image to be displayed on a display unit of the client terminal 300. The image of the updated portion is not limited to an image of a rectangle but may have a shape other than a rectangle.

The server side remote screen control application also has a function of compressing data of a portion where the displacement is large between frames by a data compression scheme for a moving image to transmit the compressed data to the client terminal 300. For example, the server side remote screen control application divides a screen generated from a result of processing performed by the application into a plurality of areas and monitors a frequency (change frequency) of change for each divided area. At this time, the server side remote screen control application determines the change frequency less frequently for an area (non-displayed area) which is not currently displayed in the display unit of the client terminal 300 than for an area (displayed area) which is currently displayed in the display unit of the client terminal 300, among the displayable area. The server side remote screen control application may decrease the number of the frame capturing for an area that is not displayed in the display unit of the client terminal 300 so as to reduce the processing load. The server side remote screen control application transmits attribute information of an area (frequently changed area) for which the change frequency exceeds a threshold value to the client terminal 300. In addition, the server side remote screen control application encodes a bitmap image of the frequently changed area into data compliant with moving picture experts group (MPEG) scheme such as MPEG-2 or MPEG-4 and then, transmits the encoded bitmap image to the client terminal 300. Here, a case where the image is compressed into data compliant with the MPEG scheme is described, but is not limited thereto. Any arbitrary compression coding scheme such as, for example, motion joint photographic experts group (Motion-JPEG), may be employed as long as the compression scheme targets a moving image.

The client terminal 300 is a computer which is provided with a remote screen control service by the GW server 200. For example, a tablet terminal or a smartphone may be employed as an example of the client terminal 300. Further, a fixed terminal such as a personal computer may be employed in addition to a mobile terminal such as a mobile phone, a personal handy-phone system (PHS), or a personal digital assistant (PDA) as other examples of the client terminal 300. An application for a remote screen control for a client is installed or pre-installed in the client terminal 300. In the following, the application for a remote screen control for a client may be referred to as a “client side remote screen control application”.

The client side remote screen control application has a function of notifying the GW server 200 of operation information received through various input devices such as a touch panel, a mouse, or a keyboard. For example, the client side remote screen control application notifies, as the operation information, an amount of a pan operation, an amount of a flick operation, or tapping, on a touch panel integrally formed with the display unit. As another example, the client side remote screen control application notifies, as the operation information, a left clicking, a right clicking, a double clicking, and a dragging of a mouse, or a movement amount of a mouse cursor obtained through a moving operation of the mouse. As still another example, the client side remote screen control application also notifies, as the operation information, a rotation amount of a mouse wheel, or information on a pressed key among keys on a keyboard.

Further, the client side remote screen control application has a function of holding an image received from the GW server 200 in an image cache and allowing the display unit to display the image. The image cache described above refers to a cache memory storing the displayable area. As an example, when a bitmap image of an updated rectangle is received from the GW server 200, the client side remote screen control application displays the bitmap image of the updated rectangle on a position where a change has occurred from the previous bitmap image. As another example, when the attribute information of the frequently changed area is received from the GW server 200, the client side remote screen control application reserves an area on the display screen corresponding to a position specified in the attribute information as a blank area which is not to be used for displaying the bitmap image. After that, when data compressed by a compression scheme for a moving image is received, the client side remote screen control application decodes the data and displays the data in the blank area.

Further, when a scroll operation is input by the user, the client terminal 300 displays a corresponding area of the displayable area stored in the image cache in the display unit depending on an amount of the scroll operation. The scroll operation is, for example, a pan operation or a flick operation.

Next, descriptions will be made on a functional configuration of a Web server according to the present embodiment. As illustrated in FIG. 1, a Web server 100 includes a communication unit 101, a reading unit 102, and a storage unit 103. The Web server 100 is assumed to have functions of various known functional units such as, for example, various input devices or display devices equipped in a computer in addition to the functional units illustrated in FIG. 1.

The communication unit 101 is implemented by, for example, a network interface card (NIC). The communication unit 101 is connected with the GW server 200 by a wired line or wirelessly through the network and is a communication interface responsible for the communication of information with the GW server 200. The communication unit 101 receives a page request from the GW server 200 and outputs the received page request to the reading unit 102. Further, the communication unit 101 transmits the page input from the reading unit 102 to the GW server 200.

When the page request is input from the communication unit 101, the reading unit 102 reads a corresponding page from the storage unit 103. For example, when a predetermined uniform resource locator (URL) is input as the page request, the reading unit 102 reads a page corresponding to the predetermined URL from the storage unit 103. The reading unit 102 outputs the read page to the communication unit 101.

The storage unit 103 stores therein the page. The page is described in, for example, the hypertext markup language (HTML) and may include, for example, an image. The page may be a dynamic page using, for example, Java (registered trademark) applet, Java (registered trademark) EE (Java Platform, Enterprise Edition), Flash (registered trademark), and Ajax. In addition, the page may include, for example, a JPEG compliant still image or an MPEG-2 or MPEG-4 compliant moving image.

Next, descriptions will be made on a functional configuration of a GW server according to the present embodiment. As illustrated in FIG. 1, a GW server 200 includes an OS execution control unit 201, a first communication unit 202, a screen generation unit 203, a frame buffer 204, a displayable area generation unit 205, a change frequency determination unit 206, a frequently changed area identifying unit 207, and an encoder 208. Further, the GW server 200 includes a second communication unit 209, an operation information acquisition unit 210, an image cache management unit 211, and a communication control unit 212. Further, the GW server 200 is assumed to have functions of various known functional units such as, for example, various input devices or display devices equipped in a computer in addition to the functional units illustrated in FIG. 1.

The OS execution control unit 201 is a processing unit to control an execution of OS. For example, the OS execution control unit 201 detects an instruction to activate an application or a command for the application on the basis of the operation information acquired through the second communication unit 209. For example, when a tapping is detected on an icon of an application, the OS execution control unit 201 activates the application corresponding to the icon. Further, when an operation to request an execution of a command is detected on an operation screen so-called a window of the application being activated, the OS execution control unit 201 instructs the application to execute the command. The OS execution control unit 201 includes a frame buffer 204 storing a remote screen and the image of screen of each application and controls the entirety of the remote screen.

The first communication unit 202 is implemented by, for example, a NIC. The first communication unit 202 is a communication interface which is connected with the Web server 100 by a wired line or wirelessly through the network and is responsible for communication of information with the Web server 100. The first communication unit 202 transmits a page request to the Web server 100. Further, the first communication unit 202 receives a page from the Web server 100.

The screen generation unit 203 performs generation of a screen on the basis of the page input from the first communication unit 202. For example, the screen generation unit 203 is equipped with a Web browser as an application and generates an image corresponding to a page in accordance with , for example, an HTML of the page. That is, the screen generation unit 203 generates an image of an area appearing in a display screen (may also be referred to as a “Web browser screen”) and renders the image to be stored in the frame buffer 204. In other words, the screen generation unit 203 may be regarded as a unit which generates an image to be held in the image cache of the client terminal 300. When the OS is the Windows (registered trademark), the display screen has a size of, for example, 1200 horizontal pixels to the maximum and 2048 vertical pixels to the maximum.

The screen generation unit 203 controls an application or performs generation of a screen on the basis of an instruction by the OS execution control unit 201. For example, when an instruction to activate an application is issued or an instruction to execute a command is issued to an application being activated by the OS execution control unit 201, the screen generation unit 203 operates the application. Also, the screen generation unit 203 generates an image of processing results obtained by operating the application and renders the image to be stored in the frame buffer 204.

The frame buffer 204 is a storage device storing a bitmap image which is an image corresponding to the entirety of the page rendered by the screen generation unit 203. The frame buffer 204 may be implemented by a semiconductor memory device such as a random access memory (RAM) including a video RAM (VRAM), a read-only memory (ROM), or a flash memory. The frame buffer 204 may be implemented by a storage device such as a hard disk or an optical disk.

The displayable area generation unit 205 generates an image of a displayable area to be held in an image cache 306 of the client terminal 300. For example, the displayable area generation unit 205 activates the following processing each time when bitmap data is stored in the frame buffer 204 by the screen generation unit 203. That is, the displayable area generation unit 205 compares a screen data frame generated at the time of the previous frame generation with a screen data frame written into the frame buffer 204 at the time of the current frame generation. The displayable area generation unit 205 generates an image of an updated rectangle shaped into a rectangle after pixels of a portion having been changed from the previous frame are connected with each other, and outputs the image to the change frequency determination unit 206.

When bitmap data of a page next to a currently displayed page is stored in the frame buffer 204 by the screen generation unit 203, the displayable area generation unit 205 generates an image according to the maximum screen size of the displayable area and outputs the image to the image cache management unit 211. Regarding a page generated for the first time, when bitmap data of the page generated for the first time is stored in the frame buffer 204 by the screen generation unit 203, the displayable area generation unit 205 also generates an image according to the maximum screen size of the displayable area and outputs the image to the image cache management unit 211.

The change frequency determination unit 206 determines a change frequency between frames for each area formed by dividing the image rendered in the frame buffer 204. For example, the change frequency determination unit 206 accumulates the updated rectangle generated by the displayable area generation unit 205 in an internal work memory (not illustrated) for a predetermined period. At this time, the change frequency determination unit 206 accumulates attribute information capable of identifying the position and size of the updated rectangle, for example, the coordinates of an upper left vertex of the updated rectangle and the width and height of the updated rectangle. The period during which the updated rectangle is accumulated has a correlation with accuracy in identifying the frequently changed area, and an erroneous detection of a frequently changed area is reduced as the period becomes longer. As an example, the change frequency determination unit 206 may accumulate the updated rectangle for one second.

When a predetermined period has elapsed after the image of the updated rectangle is accumulated, the change frequency determination unit 206 determines the change frequency of the displayable area to be held in the image cache 306 of the client terminal 300 using a map formed by dividing the displayable area into a mesh shape. The change frequency determination unit 206 determines the change frequency less frequently for the non-displayed area than for the area currently displayed in the display unit of the client terminal 300, among the displayable area. As an example, the change frequency determination unit 206 determines the change frequency for the area currently displayed in the display unit of the client terminal 300 among the displayable area at 30 frames per second (FPS). The change frequency determination unit 206 determines the change frequency for the area which is not displayed in the display unit of the client terminal 300 among the displayable area at 2 FPS. Accordingly, the change frequency determination unit 206 decreases the number of frame capturing for the area which is not displayed in the display unit of the client terminal 300 so as to reduce the processing load.

The frequently changed area identifying unit 207 identifies an area which is changed at a high frequency among the displayable area held in the image cache 306 of the client terminal 300 as a frequently changed area. For example, when some meshes are determined to have the number of changes exceeding a threshold value by the change frequency determination unit 206, the frequently changed area identifying unit 207 reshapes a mesh connected body formed by connecting adjacent meshes into a rectangle. As an example, the frequently changed area identifying unit 207 derives interpolation areas to be interpolated in the mesh connected body and then adds all the interpolation areas to the mesh connected body so as to reshape the mesh connected body into a rectangle. An algorithm that derives areas with which the mesh connected body is shaped into a rectangle by the minimum interpolations is applied to the derivation of the interpolation area. The “threshold value” is set by causing an end user to select one of values set in a stepwise manner by a developer of the server side remote screen control application, or directly set by the end user. Various known methods may be used as a method of identifying the frequently changed area by the frequently changed area identifying unit 207.

The encoder 208 encodes the image of the frequently changed area input from the frequently changed area identifying unit 207. For example, the encoder 208 encodes the bitmap image of the frequently changed area when the bitmap image of the frequently changed area input from the frequently changed area identifying unit 207 reaches the number of frames capable of forming a stream. Encoding schemes may include an MPEG scheme such as MPEG-2 or MPEG-4, or a Motion-JPEG scheme.

The second communication unit 209 is implemented by, for example, a NIC. The second communication unit 209 is a communication interface which is connected with the client terminal 300 by a wired line or wirelessly through the network and is responsible for communication of information with the client terminal 300. For example, the second communication unit 209 transmits the image of the updated rectangle generated by the displayable area generation unit 205 and the attribute information of the updated rectangle to the client terminal 300. The RFB protocol used in the VNC is, for example, employed as a communication protocol used to transmit the updated rectangle. The second communication unit 209 is also a processing unit transmitting the encoded image of the frequently changed area encoded by the encoder 208 to the client terminal 300. The real-time transport protocol (RTP), as an example, may be employed as a communication protocol used to transmit the encoded image of the frequently changed area.

The operation information acquisition unit 210 acquires operation information from the client terminal 300 through the second communication unit 209. An example of the operation information is operation information about a scroll event, and may include, for example, an amount of a pan operation or an amount of a flick operation on a touch panel. Another example of the operation information may include, for example, tapping on the touch panel. Further, another example of the operation information may include, for example, a left clicking, a right clicking, a double clicking, and a dragging of a mouse, or a movement amount of a mouse cursor obtained through a moving operation of the mouse. Further, another example of the operation information may include, for example, a rotation amount of a mouse wheel, or information on a pressed key among keys on a keyboard.

The image cache management unit 211 manages the image cache 306 of the client terminal 300. This is for synchronizing the displayable area held in the image cache 306 of the client terminal 300 with the Web browser screen. For example, when the operation information acquired by the operation information acquisition unit 210 is information about a scroll event, the image cache management unit 211 stores positional information of an area currently displayed in the display unit 308 of the client terminal 300 after the scroll event. The positional information indicates a position within the displayable area. When the operation information acquired by the operation information acquisition unit 210 is information about an event for scrolling the Web browser screen, the image cache management unit 211 transmits a page request for the next page to the Web server 100 through the first communication unit 202. Thereafter, the screen generation unit 203 generates an image corresponding to the next page input in response to the page request and renders the image to be stored in the frame buffer 204. The image cache management unit 211 outputs the image according to the maximum screen size of the displayable area output from the displayable area generation unit 205 to the second communication unit 209.

The communication control unit 212 controls communication of the second communication unit 209. For example, the communication control unit 212 transmits an image of an updated rectangle in an area currently displayed in the client terminal 300 in advance of an image of an updated rectangle in a non-displayed area in the client terminal 300 using the positional information of the area currently displayed in the display unit 308 in the client terminal 300. Further, when the image of the updated rectangle in the non-displayed area is transmitted, the communication control unit 212 may transmit the image of the updated rectangle in the area located in a movement direction within the displayable area in advance of other image of the updated rectangle in the non-displayed area.

Further, the communication control unit 212 estimates an available bandwidth of a communication path between the client terminal 300 and the GW server 200. The communication control unit 212 estimates a bandwidth necessary for transmitting the updated image of the area currently displayed in the display unit 308 of the client terminal 300 and controls the communication such that the updated image is transmitted using the estimated bandwidth. Also, the communication control unit 212 controls the communication such that the updated image of the non-displayed area is transmitted using the remaining bandwidths. At this time, when the updated image of the non-displayed area is unable to be transmitted using the remaining bandwidths, the communication control unit 212 may simply skip the current transmission of the updated image. In other words, in such a case, the communication control unit 212 may simply increase a transmission interval of the non-displayed area by a predetermined time.

Next, descriptions will be made on a functional configuration of a client terminal according to the present embodiment. As illustrated in FIG. 1, the client terminal 300 includes an input unit 301, an operation information acquisition unit 302, a communication unit 303, a decoder 304, and a rendering processing unit 305, the image cache 306, an image cache management unit 307, and the display unit 308. Further, in addition to the functional units illustrated in FIG. 1, the client terminal 300 is assumed to have functions of various known functional units such as, for example, a voice outputting unit equipped in a computer.

The input unit 301 is an input device to receive various operations from the user. For example, the input unit 301 is implemented by a touch panel, a mouse, or a keyboard. When intending to use the touch panel as the input unit 301, the input unit 301 is integrally formed with the display unit 308 which is a display device.

The operation information acquisition unit 302 acquires operation information in response to the operation of the user received by the input unit 301. An example of the operation information is the same as that described in the operation information acquisition unit 210. That is, an example of the operation information is the operation information about a scroll event, and may include, for example, an amount of a pan operation or an amount of a flick operation on a touch panel. Another example of the operation information may include, for example, tapping on the touch panel. Further, another example of the operation information may include, for example, a left clicking, a right clicking, a double clicking, and a dragging of a mouse, or a movement amount of a mouse cursor obtained through a moving operation of the mouse. Further, another example of the operation information may include, for example, a rotation amount of a mouse wheel, or information on a pressed key among keys on a keyboard.

The communication unit 303 is implemented by, for example, a NIC and includes a transmission unit and a reception unit. The communication unit 303 is a communication interface that is connected with the GW server 200 by a wired line or wirelessly through the network and is responsible for communication of information with the GW server 200. The communication unit 303 transmits the operation information acquired by the operation information acquisition unit 302 to the GW server 200 through the network. When compressed data is received from the GW server 200, the communication unit 303 outputs the compressed data to the decoder 304 or the rendering processing unit 305. The compressed data includes the image having the maximum screen size in the displayable area.

The decoder 304 decodes the encoded image of the frequently changed area received by the communication unit 303. The decoder 304 employs a decoding scheme suitable for an encoding scheme employed by the encoder 208 of the GW server 200.

The rendering processing unit 305 renders the decoded image of the frequently changed area decoded by the decoder 304 to be stored in the image cache 306 on the basis of the attribute information of the frequently changed area received by the communication unit 303. As an example, the rendering processing unit 305 stores the decoded image of the frequently changed area in the displayable area of the image cache 306 corresponding to the position and size of the frequently changed area included in the attribute information of the frequently changed area.

Further, the rendering processing unit 305 renders the image of the updated rectangle received by the communication unit 303 to be stored in the image cache 306. As another example, the rendering processing unit 305 stores the bitmap image of the updated rectangle in the displayable area of the image cache 306 corresponding to the position and size included in the attribute information of the image of the updated rectangle received by the communication unit 303. Further, the rendering processing unit 305 performs the following processing when the attribute information of the frequently changed area is received by the communication unit 303. That is, the rendering processing unit 305 regards the displayable area of the image cache 306 corresponding to the position and size included in the attribute information of the frequently changed area as a blank area which is not to be used for displaying the bitmap image. Various methods may be used as the rendering processing method used by the rendering processing unit 305.

The image cache 306 stores therein the bitmap data rendered by the rendering processing unit 305. The image cache 306 stores a displayable area of the bitmap data to be displayed in the display unit 308. The displayable area is larger than the screen size of the display unit 308. That is, the image cache 306 is an area corresponding to the screen size of Web browser of the GW server 200. The image cache 306 may be implemented by a semiconductor memory device such as a RAM including a VRAM, the ROM, or a flash memory. The image cache 306 may be implemented by a storage device such as a hard disk or an optical disk.

The image cache management unit 307 manages the image cache 306. This is for synchronizing the displayable area held in the image cache 306 with the Web browser screen. For example, when operation information acquired by the operation information acquisition unit 302 is operation information about a scroll event, the image cache management unit 307 displays a corresponding area of the displayable area stored in the image cache 306 in the display unit 308 depending on the scroll amount included in the operation information. At this time, when the scroll amount by the operation corresponds to a movement exceeding the lower most portion of the displayable area, the image cache management unit 307 changes the scroll event to an event for scrolling the Web browser screen of the GW server 200. The image cache management unit 307 transmits operation information of the changed event to the GW server 200 through the communication unit 303. This is for causing the GW server 200 to request the Web server 100 to transmit the next page. The image cache management unit 307 displays a corresponding area of the displayable area stored in the image cache 306 in the display unit 308 depending on the scroll amount included in the operation information. Thereafter, the rendering processing unit 305 stores a bitmap image of the next page according to the maximum screen size in the displayable area of the image cache 306.

The display unit 308 is a display device displaying various kinds of information, for example, an area within the Web browser screen transmitted from the GW server 200. The display unit 308 may be implemented by a monitor, a display, or a touch device (display integrated with a touch panel).

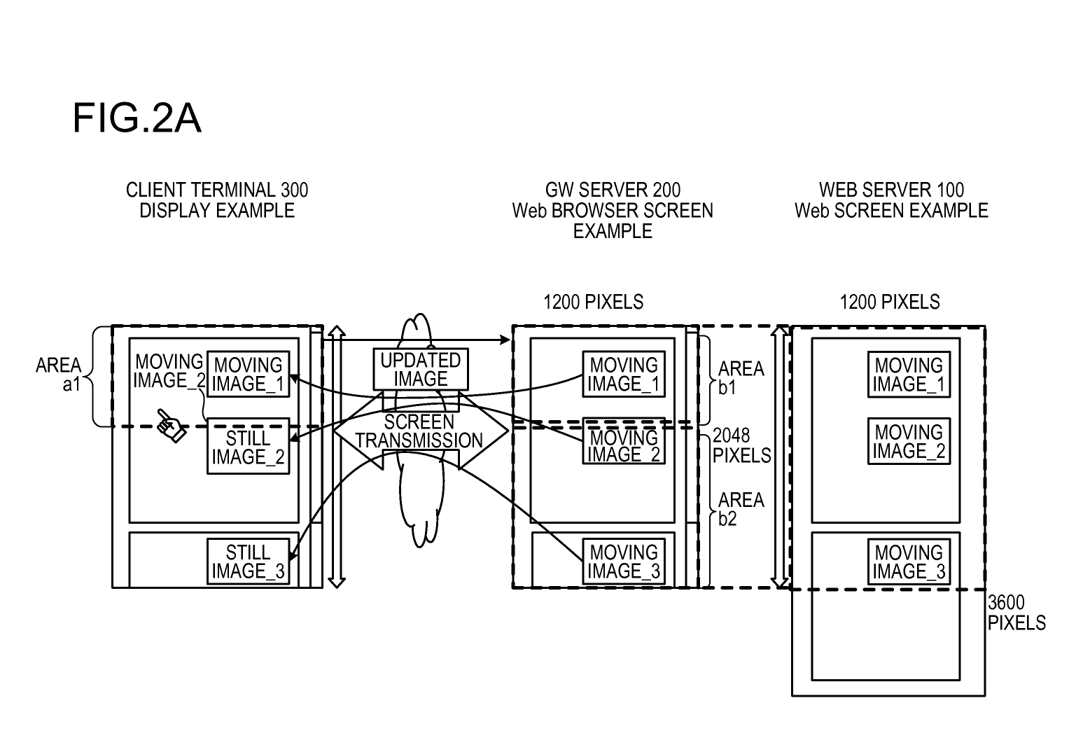

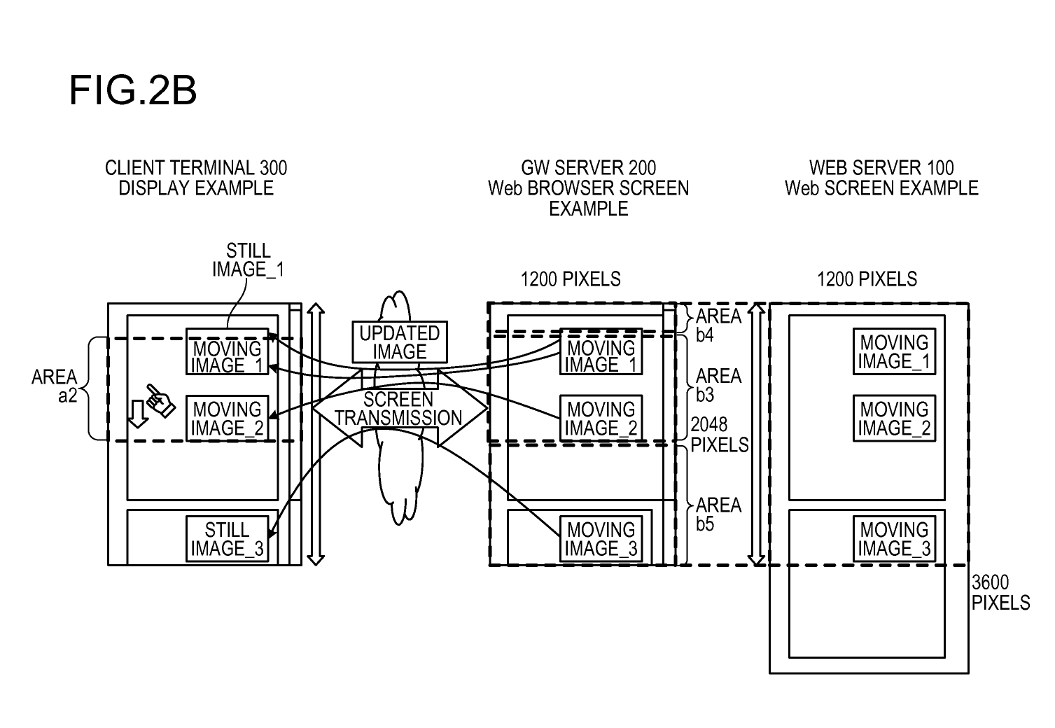

FIG. 2A and FIG. 2B are diagrams illustrating specific examples of a change frequency determination according to the embodiment. It is assumed that a page having 1200 horizontal pixels and 3600 vertical pixels is displayed in a Web screen of the Web server 100 as the entirety of contents.

As illustrated in FIG. 2A, contents having the maximum screen size of the Web browser screen among the entire contents displayed in the Web screen of the Web server 100 are being displayed in the Web browser screen of the GW server 200. It is assumed that the maximum screen size of the Web browser screen has 1200 horizontal pixels and 2048 vertical pixels. Here, three moving images (moving image_1, moving image_2, and moving image_3) are included in the Web browser screen.

In the client terminal 300, the image cache 306 stores therein, as the displayable area, an image having the same size (1200 horizontal pixels and 2048 vertical pixels) as the Web browser screen. Among the displayable area, an area currently displayed in the display unit 308 is a rectangle area having 1200 horizontal pixels and 800 vertical pixels. In FIG. 2A, a rectangle area a1 is the rectangle area currently displayed in the display unit 308 and other areas are non-displayed areas.

In the GW server 200, the image cache management unit 211 manages positional information transmitted from the client terminal 300. The positional information indicates a position of the area currently displayed in the display unit 308 within the displayable area.

In the GW server 200, the change frequency determination unit 206 determines a frequency of change between the frames for each area formed by dividing the image rendered in the frame buffer 204. At this time, the change frequency determination unit 206 determines the change frequency less frequently for the non-displayed area than for the area currently displayed in the display unit 308 among the displayable area of the client terminal 300. Here, since the rectangle area a1 is the displayed area, a rectangle area b1 corresponds to the displayed area and a rectangle area b2 corresponds to the non-displayed area. Accordingly, the change frequency determination unit 206 determines the change frequency less frequently for the non-displayed area b2 than for the displayed area b1. In the example of FIG. 2A, the change frequency determination unit 206 captures the frames at 30 FPS for the displayed area to determine the change frequency. The change frequency determination unit 206 captures the frames at 2 FPS for the non-displayed area to determine the change frequency.

As a result, the frequently changed area identifying unit 207 identifies a moving image portion in the displayed area as a frequently changed area. The second communication unit 209 transmits the encoded image of the frequently changed area to the client terminal 300 as the updated image. Here, the moving image_1 and the portion included in the displayed area among the moving image_2 is identified as a frequently changed area, and the second communication unit 209 transmits an encoded image of the frequently changed area to the client terminal 300 as an updated image. That is, the second communication unit 209 transmits the moving image portion in the displayed area as a moving image.

On the other hand, the frequently changed area identifying unit 207 does not identify the moving image portion in the non-displayed area as a frequently changed area. That is, since the determination of the change frequency is performed less frequently in the non-displayed area, the frequently changed area identifying unit 207 does not identify the moving image portion as a frequently changed area because the determination of the change frequency is performed less frequently even in the moving image portion. The second communication unit 209 transmits an image of the updated rectangle to the client terminal 300 as an updated image. That is, for the non-displayed area, the second communication unit 209 does not make a moving image even for a moving image portion and transmits an updated image as a still image. The portion included in the non-displayed area b2 among the moving image_2 and the moving image_3 are transmitted as a still image.

As illustrated in FIG. 2B, it is assumed that in the client terminal 300, the user inputs a scroll operation moving downwardly on the display unit 308. The operation information acquisition unit 302 receives operation information about the scroll event received by the input unit 301 and transmits the received operation information to the GW server 200 through the communication unit 303. A scroll amount, that is, positional information of an area displayed in the display unit 308 after the scroll within the displayable area is included in the operation information. Depending on the scroll amount included in the operation information, the image cache management unit 307 reads the corresponding area from the displayable area stored in the image cache 306 and displays the corresponding area in the display unit 308. In FIG. 2B, the rectangle area a2 is the area currently displayed in the display unit 308 and other areas are the non-displayed areas.

In the GW server 200, the image cache management unit 211 manages the positional information of the area currently displayed in the display unit 308 within the displayable area transmitted from the client terminal 300.

In the GW server 200, the change frequency determination unit 206 determines the change frequency between the frames for each area formed by dividing the image rendered in the frame buffer 204. At this time, the change frequency determination unit 206 determines the change frequency less frequently for the non-displayed area than for the area currently displayed in the display unit 308 among the displayable area of the client terminal 300. In FIG. 2B, since a rectangle area b3 corresponds to the displayed area a2 and a rectangle area b4 and a rectangle area b5 correspond to non-displayed areas. Accordingly, the change frequency determination unit 206 determines the change frequency less frequently for the non-displayed areas b4 and b5 than for the displayed area b3. In the example of FIG. 2B, the change frequency determination unit 206 captures the frames at 30 FPS for the displayed area b3 to determine the change frequency. The change frequency determination unit 206 captures the frames at 2 FPS for the non-displayed areas b4 and b5 to determine the change frequency.

As a result, the frequently changed area identifying unit 207 identifies a moving image portion (the moving image_2 and a portion of the moving image_1) in the displayed area b3 as a frequently changed area. The second communication unit 209 transmits an encoded image of the frequently changed area to the client terminal 300 as an updated image. Here, the moving image_2 and the portion included in the displayed area among the moving image_1 are identified as a frequently changed area and the second communication unit 209 transmits an encoded image of the frequently changed area to the client terminal 300 as an updated image. That is, the second communication unit 209 transmits the moving image portion in the displayed area as a moving image.

On the other hand, the frequently changed area identifying unit 207 does not identify a moving image portion in the non-displayed areas b4 and b5 as a frequently changed area. That is, since the determination of the change frequency is performed less frequently in the non-displayed area, the frequently changed area identifying unit 207 does not identify a moving image portion as a frequently changed area because the determination of the change frequency is performed less frequently even in the moving image portion. The second communication unit 209 transmits an image of the updated rectangle to the client terminal 300 as an updated image. That is, for the non-displayed area, the second communication unit 209 does not make a moving image even for a moving image portion and transmits an updated image as a still image. Thus, the moving image_3 and the portion of the moving image_1, which is included in the non-displayed area b4, are transmitted as a still image.

Accordingly, the GW server 200 may reduce a processing load caused by performing the change frequency determination processing for an area (the displayable area) larger than the display area of the display unit 308 of the client terminal 300. Further, since the GW server 200 performs image processing including the change frequency determination processing for an area (the displayable area) larger than the display area of the display unit 308 of the client terminal 300, the operability of the client terminal 300 may be improved.

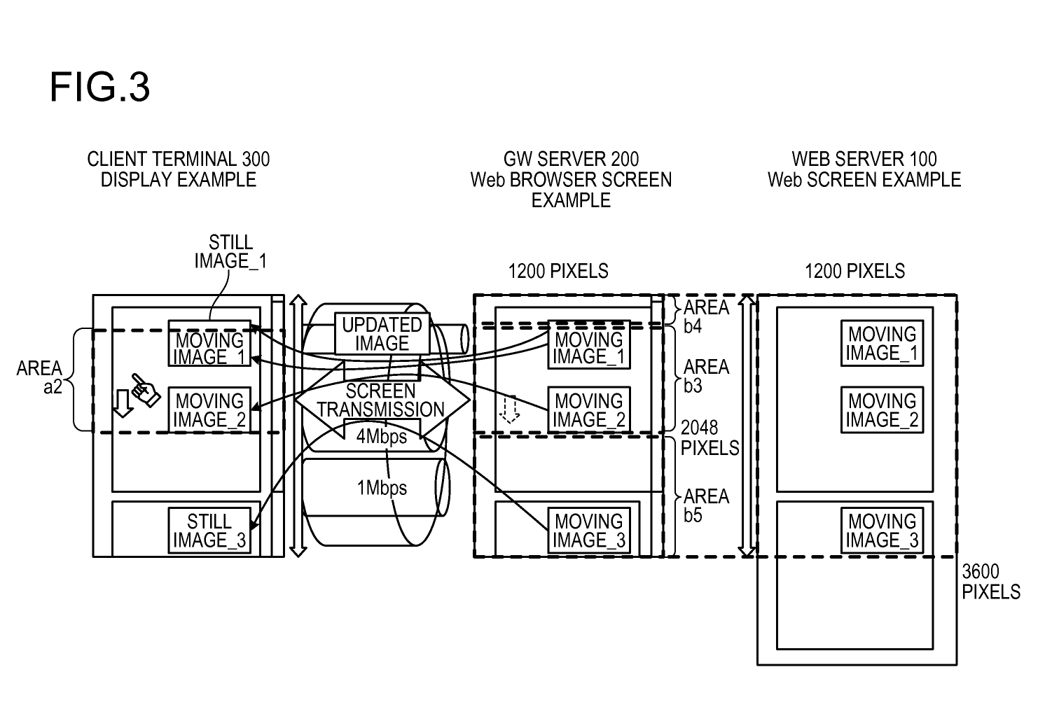

FIG. 3 is a diagram illustrating a specific example of a communication control according to the embodiment. In FIG. 3, descriptions will be made on the communication control under the same condition as that illustrated in FIG. 2B. That is, in the client terminal 300, the rectangle area a2 is an area currently displayed in the display unit 308 and an area other than the rectangle area a2 is a non-displayed area. In the GW server 200, the area b3 corresponds to the displayed area a2 and the areas b4 and b5 correspond to the non-displayed areas.

The communication control unit 212 estimates an available bandwidth of a communication path between the client terminal 300 and the GW server 200. Here, it is assumed that the available bandwidth is estimated as 5 Mbps.

Further, the communication control unit 212 estimates a bandwidth necessary for the transmission of the updated image of the displayed area b3 and controls the communication such that the updated image of the displayed area b3 is transmitted using the estimated bandwidth. Here, it is assumed that the bandwidth necessary for the transmission of the updated image of the displayed area b3 is estimated as 4 Mbps. Then, the communication control unit 212 transmits the updated image of the moving image area (the moving image_2 and a portion of the moving image_1) included in the displayed area b3 using the available bandwidth of 4 Mbps.

The communication control unit 212 controls the communication such that an updated image of the non-displayed areas b4 and b5 is transmitted using the remaining bandwidth. At this time, when the updated image of the non-displayed areas b4 and b5 is unable to be transmitted using the remaining bandwidth, the communication control unit 212 may simply skip the current transmission of the updated image. Accordingly, the communication control unit 212 transmits the image of the areas b4 and b5 corresponding to areas that are not displayed in the display unit 308 using the surplus bandwidth such that the image of the area b3 corresponding to the area currently displayed in the display unit 308 may be securely transmitted. As a result, the communication control unit 212 may ensure the operability at the client terminal 300 side.

Further, the communication control unit 212 controls the communication such that when the updated image of the non-displayed areas b4 and b5 is transmitted, the updated image of the area located in a movement direction within the displayable area is transmitted in advance of other updated image of the non-displayed area. In the example of FIG. 3, the movement direction of the scroll operation by the user is a downward direction. Then, the communication control unit 212 transmits the non-displayed area b5 located below the displayed area b3 in the downward direction in advance of the non-displayed area b4. Accordingly, the communication control unit 212 may transmit the non-displayed area b5 in the movement direction in advance of other non-displayed area such that the increase of data transfer amount caused by transmitting the moving image included in the non-displayed areas b4 and b5 as a still image may be suppressed.

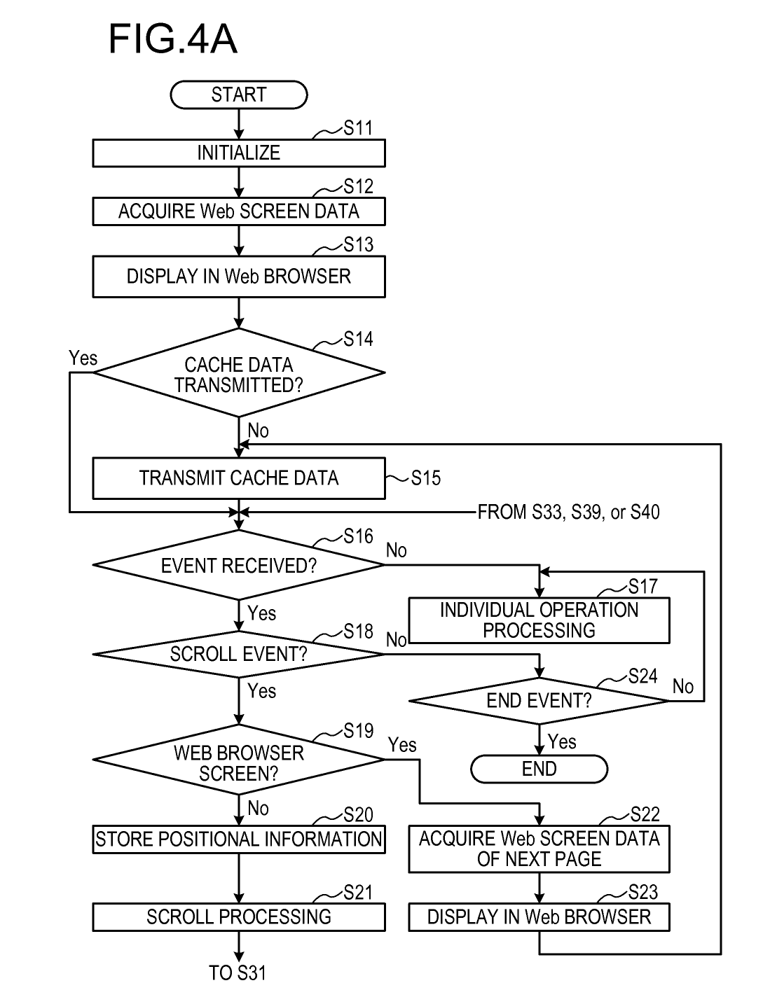

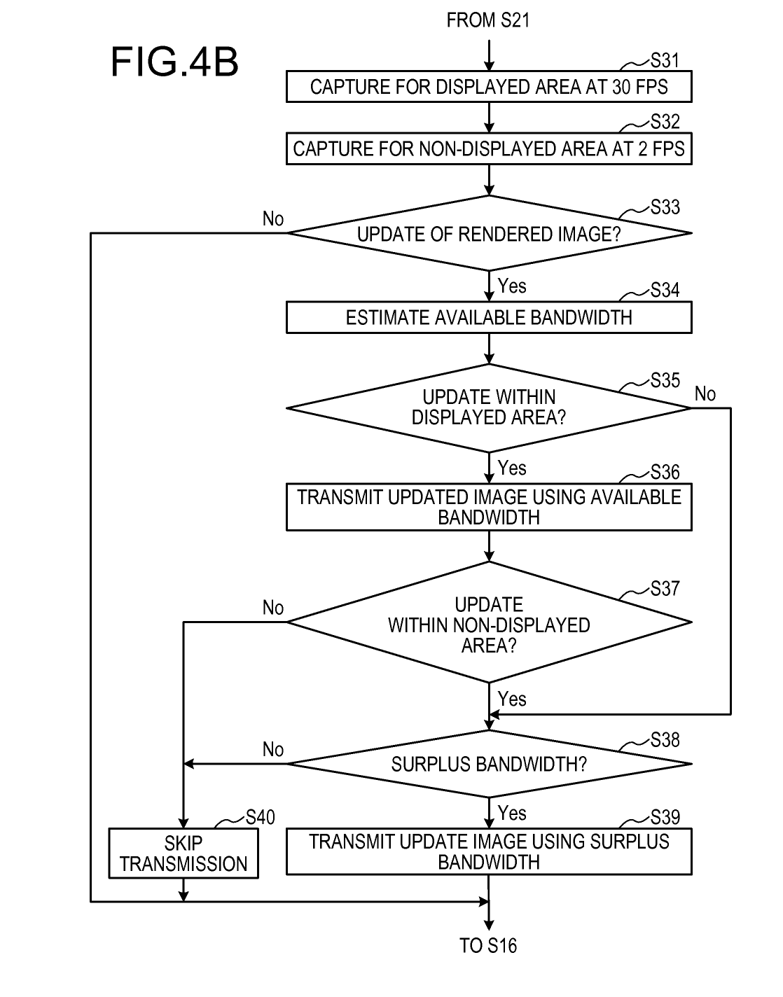

Next, descriptions will be made on a flow of an image transmission process of the GW server 200 with reference to FIG. 4A and FIG. 4B. FIG. 4A and FIG. 4B are flowcharts illustrating a flow of an image transmission process of a GW server according to the embodiment. It is assumed that the image transmission process of the GW server 200 begins when a request to provide data for a Web screen of a predetermined URL is received from the client terminal 300.

When a request to provide Web screen data of a predetermined URL is received from the client terminal 300, the screen generation unit 203 initializes the Web browser on the basis of an instruction of the OS execution control unit 201 (S11). That is, the screen generation unit 203 starts the Web browser in a maximum size.

The screen generation unit 203 acquires the Web screen data of the predetermined URL from the Web server 100 (S12). The screen generation unit 203 displays the Web screen data of the predetermined URL in the Web browser (S13). For example, the screen generation unit 203 generates an image corresponding to the Web screen data and renders the image to be stored in the frame buffer 204. The screen generation unit 203 displays the generated image on the Web browser screen.

Subsequently, the image cache management unit 211 determines whether cache data for the predetermined URL has been transmitted to the client terminal 300 (S14). The cache data described above refers to an image according to the maximum screen size of the displayable area for the predetermined URL. That is, the cache data refers to the image to be held in the image cache 306.

When it is determined that the cache data for the predetermined URL has been transmitted to the client terminal 300 (“YES” at S14), the process proceeds to S16.

When it is determined that the cache data for the predetermined URL has not been transmitted to the client terminal 300 (“NO” at S14), the image cache management unit 211 transmits the cache data to the client terminal 300 (S15). Then, the process proceeds to S16.

The operation information acquisition unit 210 determines whether an event has been received from the client terminal 300 through the second communication unit 209 (S16). When it is determined that an event has not been received from the client terminal 300 (“NO” at S16), the operation information acquisition unit 210 request the OS execution control unit 201 to execute individual operation processing according to the received request (S17).

When it is determined that an event has been received from the client terminal 300 (“YES” at S16), the operation information acquisition unit 210 determines whether the received event is a scroll event (S18). When it is determined that the received event is not a scroll event (“NO” at S18), the process proceeds to S24.

When it is determined that the received event is a scroll event (“YES” at S18), the operation information acquisition unit 210 determines whether the received event is an event for scrolling the Web browser screen (S19).

When it is determined by the operation information acquisition unit 210 that the received event is an event for scrolling the Web browser screen (“YES” at S19), the image cache management unit 211 performs the following processing. That is, the image cache management unit 211 requests the Web server 100 to provide Web screen data of the next page through the first communication unit 202. The screen generation unit 203 acquires the Web screen data of the next page (S22). The screen generation unit 203 displays the Web screen data of the next page in the Web browser (S23). The process proceeds to S15 in order to transmit cache data to the client terminal 300.

When it is determined by the operation information acquisition unit 210 that the received event is not an event for scrolling the Web browser screen (“NO” at S19), the image cache management unit 211 stores positional information of a terminal display area (S20). The positional information of the terminal display area refers to the positional information included in the operation information about the scroll event and indicates a position of an area currently displayed in the display unit 308 of the client terminal 300 within the displayable area.

The image cache management unit 211 scrolls the Web browser screen by a predetermined distance on the basis of the positional information of the terminal display area (S21).

The change frequency determination unit 206 captures a frame for an area currently displayed in the display unit 308 of the client terminal 300 at 30 FPS and determines a difference between the captured frame and the previous frame (S31). For example, the change frequency determination unit 206 determines a change frequency between the frames for each area formed by dividing the image rendered in the frame buffer 204. The change frequency determination unit 206 captures a frame for each divided area corresponding to the area currently displayed in the display unit 308 of the client terminal 300 at 30 FPS and determines the change frequency.

The change frequency determination unit 206 captures a frame for an area that is not displayed in the display unit 308 of the client terminal 300 at 2 FPS and determines a difference between the captured frame and the previous frame (S32). For example, the change frequency determination unit 206 determines a change frequency between the frames for each area formed by dividing the image rendered in the frame buffer 204. The change frequency determination unit 206 captures a frame for each divided area corresponding to the area that is not displayed in the display unit 308 of the client terminal 300 at 2 FPS and determines the change frequency.

The change frequency determination unit 206 determines whether an update of the rendered image is present (S33). When it is determined that an update of the rendered image is not present (“NO” at S33), the process proceeds to S16 in order to wait for reception of the next event.

When it is determined by the change frequency determination unit 206 that an update of the rendered image is present (“YES” at S33), the communication control unit 212 estimates a bandwidth capable of being used for transmission (available bandwidth) (S34). The communication control unit 212 determines whether an update of the rendered image is present within an area currently displayed in the display unit 308 of the client terminal 300 (S35). When it is determined that an update of the rendered image is not present within the area currently displayed in the display unit 308 of the client terminal 300 (“NO” at S35), the process proceeds to S38.

When it is determined that an update of the rendered image is present within the area currently displayed in the display unit 308 of the client terminal 300 (“YES” at S35), the communication control unit 212 performs a control such that an updated image compressed depending on a moving image or a still image is transmitted using the available bandwidth (S36). The communication control unit 212 determines whether an update of the rendered image is present within an area that is not displayed in the display unit 308 of the client terminal 300 (S37).

When it is determined that an update of the rendered image is not present within the area that is not displayed in the display unit 308 of the client terminal 300 (“NO” at S37), the communication control unit 212 skips the transmission (S40). Then, the process proceeds to S16 in order to wait for the reception of the next event.

When it is determined that an update of the rendered image is present within the area that is not displayed in the display unit 308 of the client terminal 300 (“YES” at S37), the communication control unit 212 determines whether a sufficient surplus bandwidth exists for transmission of an updated image compressed using a compression scheme for a still image (S38). When it is determined that a sufficient surplus bandwidth does not exist for transmission of an updated image compressed using a compression scheme for a still image (“NO” at S38), the process proceeds to S40 in order to skip the transmission.

When it is determined that a sufficient surplus bandwidth exists for transmission of an updated image compressed using a compression scheme for a still image (“YES” at S38), the communication control unit 212 performs the following processing. That is, the communication control unit 212 performs a control such that the update of the rendered image within the area that is not displayed in the display unit 308 of the client terminal 300 is transmitted using the compression scheme for a still image in accordance with a priority depending on the scroll direction (S39). Thereafter, the process proceeds to S16 in order to wait for the reception of the next event.

The operation information acquisition unit 210 determines whether the received event is an end event (S24). When it is determined that the received event is not an end event (“NO” at S24), the process proceeds to S17 in order to execute the individual operation processing according to the received event.

When it is determined that the received event is an end event (“YES” at S24), the operation information acquisition unit 210 terminates the process.

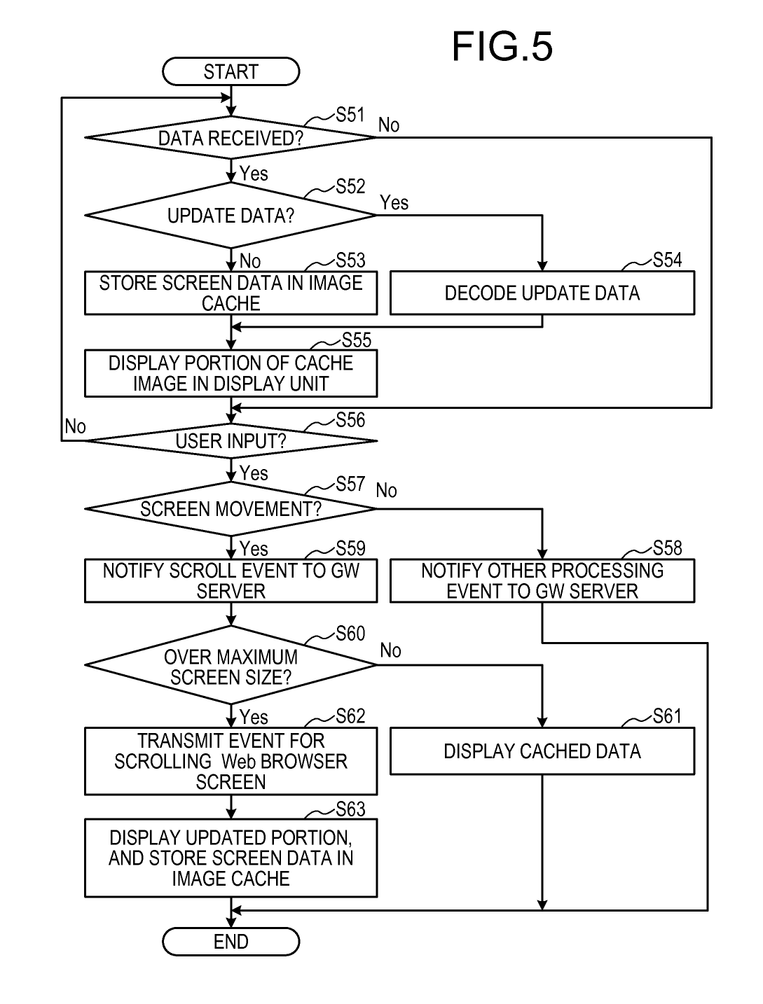

Next, descriptions will be made on a flow of an image display process by the client terminal 300 with reference to FIG. 5. FIG. 5 is a flowchart illustrating a flow of an image display process of a client terminal according to the embodiment.

The communication unit 303 determines whether data has been received from the GW server 200 (S51). When it is determined that data has not been received from the GW server 200 (“NO” at S51), the process proceeds to S56 in order to determine an input operation from the user. When it is determined that data has been received from the GW server 200 (“YES” at S51), the communication unit 303 determines whether the received data is update data (S52).

When it is determined that the received data is not update data (“NO” at S52), the received data is screen data according to the maximum screen size of the displayable area among the Web screen data, and the following processing is performed. That is, the rendering processing unit 305 stores the screen data received from the GW server 200 in the image cache 306 (S53). The process proceeds to S55.

When it is determined that the received data is update data (“YES” at S52), the following processing is performed. That is, the decoder 304 decompresses the received update data depending on the compression scheme (for moving image or for still image). The rendering processing unit 305 updates a portion of the image cache 306 corresponding to the decoded update data (S54). The process proceeds to S55.

The image cache management unit 307 displays a portion of the image cache 306 corresponding to the display area of the display unit 308 in the display unit 308 (S55). The process proceeds to S56.

The operation information acquisition unit 302 determines whether an input operation has been performed by the user (S56). When it is determined that an input operation has not been performed by the user (“NO” at S56), the process proceeds to S51 in order to determine whether the data has been received. When it is determined that an input operation has been performed by the user (“YES” at S56), the operation information acquisition unit 302 determines whether the input operation is a touch operation (screen movement) (S57).

When it is determined that the input operation is not a touch operation (screen movement) (“NO” at S57), the input operation is an operation for other processing, and the operation information acquisition unit 302 notifies an event of the other processing to the GW server 200 (S58). Then, the image display process is terminated.

When it is determined that the input operation is a touch operation (screen movement) (“YES” at S57), the operation information acquisition unit 302 notifies a scroll event to the GW server 200 (S59). The positional information within the terminal display area is included in the scroll event. The operation information acquisition unit 302 determines whether the touch operation (screen movement) requires a scroll over the maximum screen size (S60).

When it is determined that the touch operation (screen movement) does not require a scroll over the maximum screen size (“NO” at S60), the following processing is performed. That is, the image cache management unit 307 re-determines a portion to be displayed among cached data in the image cache 306 in response to the touch operation and displays the portion of the cached data in the display unit 308 (S61). Then, the process is terminated.

When it is determined that the touch operation (screen movement) require a scroll over the maximum screen size, (“YES” at S60), the following processing is performed. That is, the image cache management unit 307 changes the scroll event to an event for scrolling the Web browser screen of the GW server 200 side in response to the touch operation and transmits the event to the GW server 200 (S62).

The image cache management unit 307 displays an updated portion of the image received from the GW server 200 in the display unit 308. The image cache management unit 307 newly stores the screen data according to the maximum screen size in the image cache 306 (S63). Thereafter, the process is terminated.

According to the embodiment described above, the GW server 200 holds, in the frame buffer 204, an image of a displayable area larger than an area of an image displayed in the display unit 308 of the client terminal 300 among an image of an execution result of the Web server 100. The GW server 200 transmits a portion of the image of the displayable area held in the frame buffer 204. The GW server 200 divides the image of the displayable area into a plurality of areas and determines a frequency of change between a current frame and a previous frame for each divided area. The GW server 200 identifies an area for which the change frequency has exceeded a threshold value as a frequently changed area. The GW server 200 transmits an image of an area which is not identified as a frequently changed area by compressing the area with a first compression ratio and an image of an area identified as a frequently changed area by compressing the area with a second compression ratio higher than the first compression ratio. Also, the GW server 200 determines the change frequency for the non-displayed area less frequently than for an area currently displayed in the display unit 308 of the client terminal 300, among the displayable area. With the configuration as described above, the GW server 200 may reduce a processing load caused by performing the change frequency determination processing for the displayable area larger than the display area of the display unit 308 of the client terminal 300. Further, since the GW server 200 performs image processing including the change frequency determination processing for the displayable area larger than the display area of the display unit 308 of the client terminal 300, the operability of the client terminal 300 may be improved.

According to the embodiment, the GW server 200 transmits an image of an area currently displayed in the display unit 308 of the client terminal 300 in advance of an image of a non-displayed area. With the configuration as described above, the GW server 200 may further improve the operability of the client terminal 300.

According to the embodiment, when a position of an area currently displayed in the display unit 308 within a displayable area is received from the client terminal 300, the GW server 200 performs the following processing. The GW server 200 transmits, when transmitting an image of an area which is not displayed in the display unit 308 within a displayable area, an image of the non-displayed area located in a movement direction determined on the basis of the received position of the area in advance of another non-displayed area. With the configuration as described above, the GW server 200 transmits the image of the non-displayed area located in the movement direction within the displayable area in advance of another non-displayed area such that it is possible to suppress an increase of the data transfer amount caused by transmitting the image included in the non-displayed area by compressing the image with the first compression ratio. That is, the GW server 200 determines the frequency of change between the frames for the non-displayed area less frequently than for the area currently displayed in the display unit such that a changed area, which may be identified as a frequently changed area if the changed area is located in the displayed area, is not identified as a frequently changed area. As a result, the GW server 200 transmits a non-displayed changed area by performing the compression processing with the first compression ratio and the data transfer amount is significantly increased. Accordingly, the GW server 200 transmits, when transmitting the image of the non-displayed area, the image of the non-displayed area located in the movement direction determined on the basis of the received position of the area within the displayable area in advance of another non-displayed area such that the increase of the data transfer amount may be suppressed.

According to the embodiment, the GW server 200 transmits an image of an area which is not displayed in the display unit 308 using a surplus bandwidth remained after having been used for the transmission of an image of an area currently displayed in the display unit 308. With the configuration as described above, the GW server 200 is able to transmit the image of the area which is not displayed in the display unit 308 using the surplus bandwidth so as to securely transmit the image of the area currently displayed in the display unit 308 and thus, the operability of the client terminal 300 may be ensured.

It is not necessary that respective constitutional elements of the apparatuses illustrated are required to be configured physically as illustrated in the figures. That is, specific forms of distribution and integration of the illustrated apparatuses are not limited to those illustrated in the figures, but some or all of which may be functionally or physically distributed or integrated in any units depending on various loads and use situations.

For example, the frequently changed area identifying unit 207 and the encoder 208 of the GW server 200 may be integrated into a single compression processing unit. Further, the decoder 304 and the rendering processing unit 305 of the client terminal 300 may be integrated into a single development processing unit.

Further, the displayable area generation unit 205, the change frequency determination unit 206, the frequently changed area identifying unit 207, the encoder 208, the second communication unit 209, the operation information acquisition unit 210, the image cache management unit 211, or the communication control unit 212 provided in the GW server 200 may be configured as follows. As an example, these functional units may be provided in an external device connected with the GW server 200 through the network. As another example, these functional units are provided in respective separate devices and cooperated with each other by being connected through the network such that the functions of the GW server 200 described above may be implemented. Similarly, the operation information acquisition unit 302, the communication unit 303, the decoder 304, the rendering processing unit 305, or the image cache management unit 307 provided in the client terminal 300 may be configured as described above.

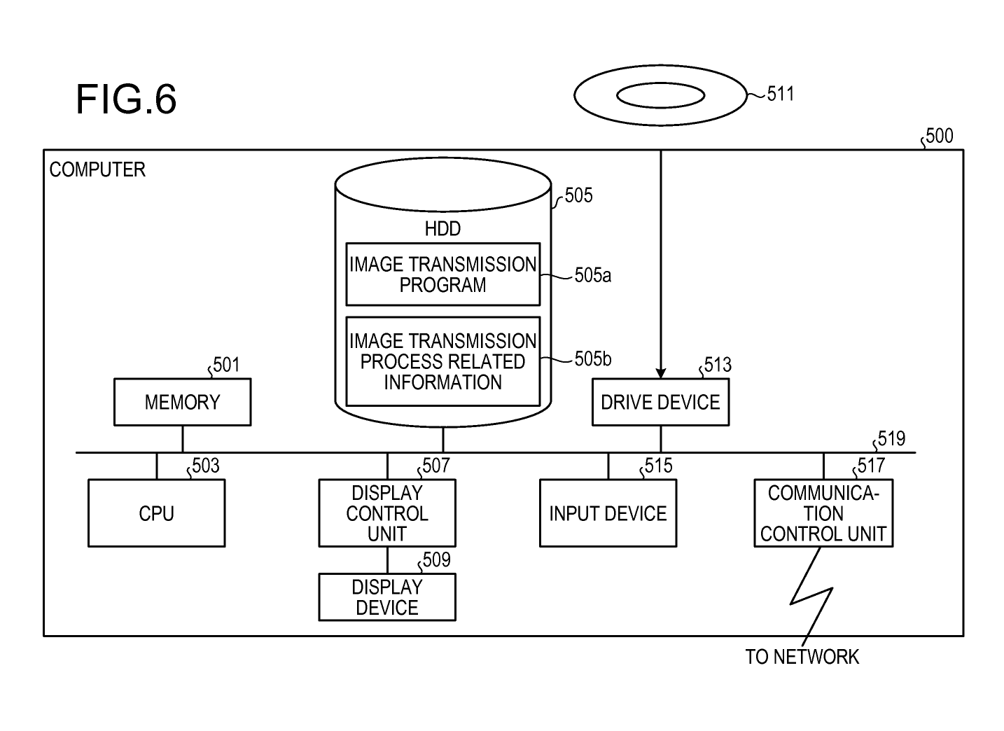

Various processing described in the embodiment described above may be implemented by executing a program prepared in advance by a computer such as, for example, a personal computer or a workstation. In the following, descriptions will be made on an example of a computer executing an image transmission program for implementing the same function as the embodiment described above with reference to FIG. 6. FIG. 6 is a diagram illustrating an example of a computer executing an image transmission program according to the embodiment. Here, descriptions will be made on an example of the computer executing the image transmission program for implementing the same function as the GW server 200, but the descriptions may be similarly applied to a case where a computer executes the image displaying program for implementing the same function as the client terminal 300.

As illustrated in FIG. 6, the computer 500 includes a central processing unit (CPU) 503 performing various arithmetic operations, an input device 515 receiving data input by the user, and a display control unit 507 controlling a display device 509. Further, the computer 500 includes a drive device 513 that reads, for example, a program from a storage medium and a communication control unit 517 that exchanges data with another computer through the network. Further, the computer 500 includes a memory 501 temporarily storing various information and a hard disc drive (HDD) 505. The memory 501, the CPU 503, the HDD 505, the display control unit 507, the drive device 513, the input device 515, and the communication control unit 517 are connected with one another through a bus 519.

The drive device 513 is, for example, a device for reading and writing data from and to a removable disk 511. The HDD 505 stores an image transmission program 505a and image transmission process related information 505b.

The CPU 503 reads the image transmission program 505a to be developed in the memory 501, and executes the image transmission program 505a to implement a process. The process corresponds to a process performed by the functional units of the GW server 200. The image transmission process related information 505b corresponds to the frame buffer 204, for example. The removable disk 511 may store information such as, for example, the image transmission program 505a.

The image transmission program 505a is not necessarily stored in the HDD 505 from the beginning. For example, the program may be stored in a portable physical recording medium to be inserted in the computer 500 such as, for example, a flexible disk (FD), a compact disc ROM (CD-ROM), a digital versatile disc (DVD), an opto-magnetic disk, or an integrated circuit (IC) card. The computer 500 may read the image transmission program 505a from the portable physical recording medium and executes the image transmission program 505a.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus, comprising:
an image memory configured to
hold an image of a displayable area larger than an area of an image displayed in a display unit of a terminal device; and
a processor configured to
transmit the image of the displayable area held in the image memory to the terminal device,
divide the displayable area into a plurality of divided areas,
determine a change frequency for each of the plurality of divided areas such that the change frequency is determined less frequently for a non-displayed divided area than for a displayed divided area, the change frequency being a frequency of change in an image of each of the plurality of divided areas, an image of the non-displayed divided area not being displayed in the display unit of the terminal device, an image of the displayed divided area being currently displayed in the display unit of the terminal device,
identify, as a frequently changed area, a divided area for which the change frequency exceeds a predetermined threshold value,
compress an image of a first divided area with a first compression ratio to obtain a first compressed image, the first divided area not being identified as the frequently changed area,
compress an image of a second divided area with a second compression ratio higher than the first compression ratio to obtain a second compressed image, the second divided area being identified as the frequently changed area, and
transmit the first compressed image and the second compressed image to the terminal device.

2. The information processing apparatus according to claim 1, wherein
the processor is configured to
transmit the image of the displayed divided area in advance of the image of the non-displayed divided area.

3. The information processing apparatus according to claim 2, wherein
the processor is configured to
receive positional information of a first image displayed in the display unit of the terminal device from the terminal device, the positional information indicating a position of the first image within the displayable area, and
transmit an image of a first non-displayed divided area in advance of an image of a second non-displayed divided area, the first non-displayed divided area being located in a movement direction within the displayable area, the second non-displayed divided area not being located in the movement direction, the movement direction being determined on basis of the positional information.

4. The information processing apparatus according to claim 2, wherein
the processor is configured to
transmit the image of the non-displayed divided area using a surplus bandwidth among an available bandwidth, the surplus bandwidth being a difference between the available bandwidth and a bandwidth used for transmitting the images of all of the displayed divided areas.

5. A terminal device, comprising:
an image memory configured to
hold an image of a displayable area larger than an area of an image displayed in a display unit; and
a processor configured to
decompress, upon receiving compressed image data of a first area among the displayable area from an information processing apparatus, the received compressed image data,
update data of the first area stored in the image memory with the decompressed data,
transmit to the information processing apparatus, upon detecting a request to move an area displayed in the display unit, positional information of a second area to be displayed after the move, the positional information indicating a position of the second area within the displayable area,
read an image of the second area from the image memory, and
display the image of the second area in the display unit.

6. A computer-readable recording medium having stored therein a program that causes a computer to execute a process, the process comprising:
storing an image of a displayable area in an image memory, the displayable area being larger than an area of an image displayed in a display unit of a terminal device;
transmitting the image of the displayable area stored in the image memory to the terminal device;
dividing the displayable area into a plurality of divided areas;
determining a change frequency for each of the plurality of divided areas such that the change frequency is determined less frequently for a non-displayed divided area than for a displayed divided area, the change frequency being a frequency of change in an image of each of the plurality of divided areas, an image of the non-displayed divided area not being displayed in the display unit of the terminal device, an image of the displayed divided area being currently displayed in the display unit of the terminal device;
identifying, as a frequently changed area, a divided area for which the change frequency exceeds a predetermined threshold value;
compressing an image of a first divided area with a first compression ratio to obtain a first compressed image, the first divided area not being identified as the frequently changed area;
compressing an image of a second divided area with a second compression ratio higher than the first compression ratio to obtain a second compressed image, the second divided area being identified as the frequently changed area; and
transmitting the first compressed image and the second compressed image to the terminal device.
